(19) United States
(12) Patent Application Publication
(10) Pub. No.: US 2002/0158909 A1
(43) Pub. Date: Oct. 31, 2002

(54) APPARATUS FOR OUTPUTTING RELATION OF DEPENDENCY OF FILES AND METHOD THEREOF

(76) Inventors: HISASHI NEGISHI, TOKYO (JP); SATOSHI MIYAGAWA, TOKYO (JP)

Correspondence Address: STAAS & HALSEY LLP, 700 11TH STREET, NW, SUITE 500, WASHINGTON, DC, 20001, US

(21) Appl. No.: 08/935,704

(22) Filed: Sep. 23, 1997

(30) Foreign Application Priority Data
Dec. 27, 1996 (JP) 08-351345
Aug. 15, 1997 (JP) 09-220303

(51) Int. Cl. G09G 5/00

(52) U.S. Cl. 345/769

(57) ABSTRACT

When a file and a directory (folder) are displayed as icons, if the user tries to place the file in a trash area or move the file to a different directory, the relation of dependency between the file being operated and another file that uses the file being operated is displayed with a line that connects the icons of these files. Thus, the user can know that these files have the relation of dependency. In addition, when the file being operated is tried to be placed in a predetermined region including the trash area, an alarm sound is generated. In addition, when the file is tried to be moved to a location where the file cannot be searched, an alarm sound is also generated.

### BACKGROUND OF THE INVENTION

1. Field of the Invention

The present invention relates to a system for explicitly outputting the relation of dependency between a file that uses another file and a file that is used by another file (the former and the latter are referred to as referring side file and referred side file).

2. Description of the Related Art

Nowadays, personal computers that have an operating system that graphically displays files as icons (this operating system is referred to as a windows-type operating system) have been marketed. With the windows-type operating system, even novice users can easily use the functions of the personal computers. Particularly, in the windows-type operating system, just by clicking a desired icon or a desired menu with a mouse, the user can use the desired function. Thus, the operation of the windows-type operating system is easier than the operation of the conventional command-input type operating system. Consequently, the windows-type operating system has been widely used.

On the other hand, since the windows-type operating system graphically processes each function, the program structure of the system is bigger and more complicated than the command-input type operating system.

In the windows-type operating system, the user can easily operate not only programs of the system, but also files recorded on a recording medium such as a floppy disk, without deep knowledge about the system.

The operation of such files is performed by a file management utility built into the windows-type operating system. The hierarchical structure of files and directories that store files is graphically displayed on the display unit. The files and the directories are operated with the mouse or the like.

In the file management utility of the windows-type operating system, in addition to user files, system files are displayed. Thus, these files can be operated in the same manner.

File operations performed by the user include a file name change operation, file delete operation, and directory change operation. In the windows-type operating system, the file delete operation is performed by dragging a desired file or a desired directory (folder) to a trash area on the display with the mouse. The directory change operation is performed by dragging a desired file or a desired directory to a destination directory with the mouse.

Although files and folders are easily operated, a necessary file may be mistakenly deleted or moved to an improper folder. Thus, a file necessary for executing a particular program may be deleted or such a file may not be searched.

When such a situation takes place in a file or a folder that composes the windows-type operating system, the operating system itself does not normally work. Thus, at that point, the system should be reinstalled to the terminal unit.

In particular, the novice users who are not familiar with the system tend to unnecessarily delete files and change the locations of folders. In addition, they do not know how to install the system. Thus, these users should consultant user support service material.

Consequently, the users should know the relation of the dependency of files so that they do not mistakenly delete files that have the relation of the dependency therebetween and that they do not move files to improper directories (folders). To check the relation of the dependency of such files, the users should spend a lot of time. Thus, the current windows-type operating system is not a user-friendly interface.

### SUMMARY OF THE INVENTION

A first aspect of the present invention is an apparatus for graphically displaying a file and operating the file, and for outputting the relation between a first file and a second file when the first file is operated, the first file using the second file when the first file is executed.

A second aspect of the present invention is a recording medium storing a program that causes a computer for graphically displaying files and performing a file operation through instructions from the user, to perform the function of outputting the relation between a first file and a second file when the first file is operated, the first file using the second file when the first file is executed.

A third aspect of the present invention is an apparatus for graphically displaying a file and operating the file, comprising detecting means for detecting whether or not a file is being operated, searching means for searching for a file with the relation of dependency to the file detected by the detecting means, and alarming means for generating an alarm when the searching means has obtained a file with the relation of dependency to the file detected by the detecting means.

A fourth aspect of the present invention is an apparatus for graphically displaying a file and operating the file, comprising detecting means for detecting whether or not a file is being operated, searching means for searching a file with the relation of dependency to the file detected by the detecting means, determining means for determining whether or not the relation of dependency between the file obtained by the searching means and the file detected by the detecting means might be destroyed by the file operation, and alarming means for generating an alarm only when the determining means has determined that the relation of dependency might be destroyed.

A fifth aspect of the present invention is a recording medium storing a program that causes a computer for graphically displaying a file and operating the file through instructions from the user, to perform the functions of detecting whether or not a file is being operated, searching for a file with the relation of dependency to the file detected by the detecting function, and generating an alarm when the searching function has obtained a file with the relation of dependency to the file detected by the detecting function.

A sixth aspect of the present invention is a recording medium storing a program that causes a computer for graphically displaying a file and operating the file through instructions from the user, to perform the functions of detecting whether or not a file is being operated, searching for a file with the relation of dependency to the file detected by the detecting function, determining whether or not the relation of dependency between the file obtained by the searching function and the file detected by the detecting function might be destroyed by the file operation, and generating an alarm only when the determining function has determined that the relation of dependency might be destroyed.

A seventh aspect of the present invention is a method for graphically displaying a file and operating the file, comprising the steps of outputting the relation between a first file and a second file when the first file is operated, the first file using the second file when the first file is executed.

An eighth aspect of the present invention is a method for graphically displaying a file and operating the file, comprising the steps of outputting the relation between a first file and a second file when the second file is operated, the first file using the second file when the first file is executed.

A ninth aspect of the present invention is a method for graphically displaying a file and operating the file, comprising the steps of detecting whether or not a file is being operated, searching for a file with the relation of dependency to the file detected by the detecting step, and generating an alarm when the searching step has obtained a file with the relation of dependency to the file detected by the detecting step.

A tenth aspect of the present invention is a method for graphically displaying a file and operating the file, comprising the steps of detecting whether or not a file is being operated, searching for a file with the relation of dependency to the file detected by the detecting step, determining whether or not the relation of dependency between the file obtained by the searching step and the file detected by the detecting step might be destroyed by the file operation, and generating an alarm only when the determining step has determined that the relation of dependency might be destroyed.

According to the present invention, when the user is operating a file, a file with the relation of dependency thereto is explicitly indicated. Thus, the user can take care not to mistakenly delete a necessary file or move a necessary file with the relation of dependency to an executable file to a location where it cannot find the necessary file. Consequently, novice users who are not familiar with system structure and file operations can be prevented from mistakenly destroying the file structure.

In other words, the user does not need to determine whether a file being operated has the relation of dependency to other files. Since the relation of dependency between files is explicitly indicated, a more user-friendly interface for managing files can be provided.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a schematic diagram showing an outline of the hardware structure of a system according to the present invention;

FIG. 2 is a schematic diagram showing an example of a display according to the present invention;

FIG. 3 is a flowchart (No. 1) showing the overall process of the system according to an embodiment of the present invention;

FIGS. 4A and 4B are flowcharts (No. 2) showing the overall process of the system according to the embodiment of the present invention;

FIG. 5 is a list showing an example of the structure of a database used in the system shown in FIG. 3;

FIG. 6 is a flowchart showing a database creating process;

FIG. 7 is a flowchart showing a file dependency searching process;

FIGS. 8A and 8B are lists showing a C language source file and a system file of the windows-type operating system;

FIGS. 9A and 9B are schematic diagrams showing a record storage format of a system file of the windows-type operating system;

FIG. 10 is a flowchart showing a process for extracting a file name from executable files of the windows-type operating system;

FIGS. 11A to 11C are schematic diagrams showing a first example of a process for generating an alarm in the case that the relation of dependency of files is described as relative locations;

FIGS. 12A and 12B are schematic diagrams showing a second example of a process for generating an alarm in the case that the relation of dependency of files is described as relative locations;

FIGS. 13A to 13C are schematic diagrams showing an example of a process for generating an alarm in the case that the relation of dependency of files is described as absolute locations;

FIGS. 14A and 14B are schematic diagrams showing an example of a process for generating no alarm in the case that the relation of dependency of files is described as relative locations;

FIGS. 15A and 15B are schematic diagrams showing an example of a process for generating no alarm in the case that the relation of dependency of files is described as absolute locations;

FIGS. 16A and 16B are flowcharts for explaining a process according to another embodiment of the present invention; and

FIGS. 17A and 17B are schematic diagrams showing examples of a message and an animation displayed on screens.

### DESCRIPTION OF PREFERRED EMBODIMENTS

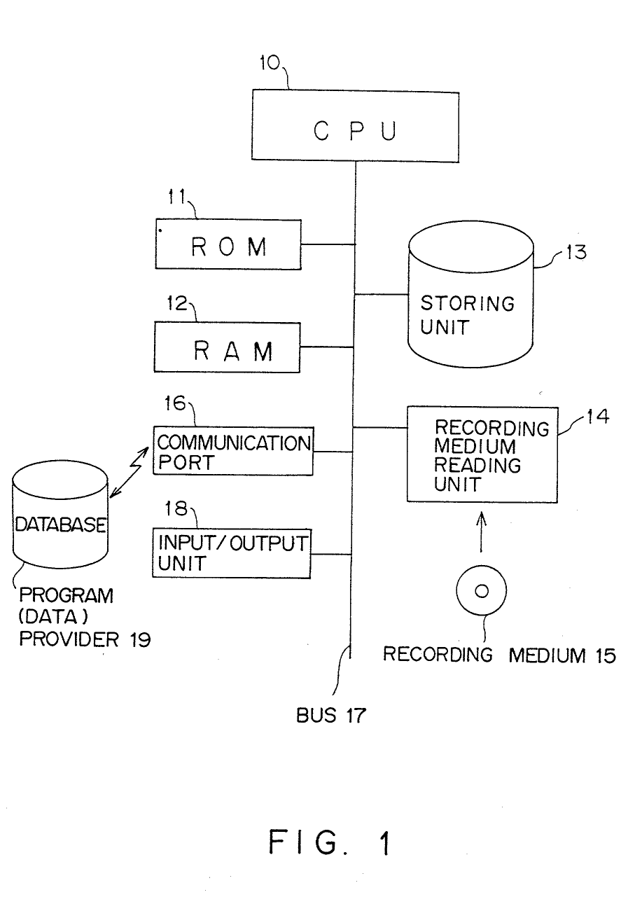

FIG. 1 shows an outline of the hardware structure of the system according to the present invention.

The present invention is based on a general purpose computer having the hardware structure of a conventional personal computer.

In other words, as shown in FIG. 1, a ROM 11, a RAM 12, a storing unit 13, a recording medium reading unit 14, an input/output unit 18, and a communication port 16 are connected to a CPU 10 through a bus 17. The ROM 11 stores a BIOS or the like that controls input/output operations to/from a terminal unit such as a personal computer. When the CPU 10 loads the BIOS or the like, the CPU allows data to be input from the keyboard and data to be output to the display screen.

The storing unit 13 stores a windows-type operating system, applications programs, and so forth. The storing unit 13 is, for example, a hard disk unit. When the terminal unit is started, the CPU 10 reads the windows-type operating system from the storing unit 13 and stores it in the RAM 12 so that the windows-type operating system can be executed.

The RAM 12 stores the windows-type operating system, the other applications, and so forth so that the CPU 10 can execute these programs.

The recording medium reading unit 14 and the recording medium 15 are, for example, a floppy disk drive and a floppy disk or a CD-ROM drive and a CD-ROM. In other words, a file such as a program stored in a portable recording medium is read to the RAM 12 so that the file can be referenced or executed. For example, the recording medium 15 stores an application program. The application program is read from the recording medium reading unit 14 to the RAM 12 so that the user can use the application program. Thus, a file relation displaying program according to the present invention can be stored in the recording medium 15. By reading the file relation displaying program from the recording medium reading unit 14, the CPU 10 can execute it.

The communication port 16 connects other units so as to enrich the functions of the terminal unit. For example, by connecting a printer, a scanner, and the like to the communication port 16, data can be printed and images can be retrieved. Alternatively, by connecting a communication modem to the communication port 16, a computer communication or the like can be performed. For example, with the computer communication, the user of the terminal unit can access a database of a program (data) provider 19 and download a desired program therefrom. Thus, the program that performs the process for outputting the relation of dependency of files according to the present invention may be downloaded from the database of the program (data) provider 19 and recorded in the storing unit 13. Thereafter, the program is read to the RAM 12 and then executed by the CPU 10.

The input/output unit 18 is, for example, a keyboard and a display unit. In addition, the input/output unit 18 includes a mouse or the like. The input/output unit 18 sends a command issued by the user to the CPU 10 or displays a calculated result of the CPU 10 so that the user can see it. In addition, when the program that outputs the relation of dependency of files according to the present invention is executed, a speaker or the like may be disposed in the input/output unit 18 so as to generate an alarm sound to the user.

The hardware structure shown in FIG. 1 is only an example. According to the present invention, a conventional general purpose personal computer or the like that operates the windows-type operating system (for example, Microsoft Windows 95) can be used.

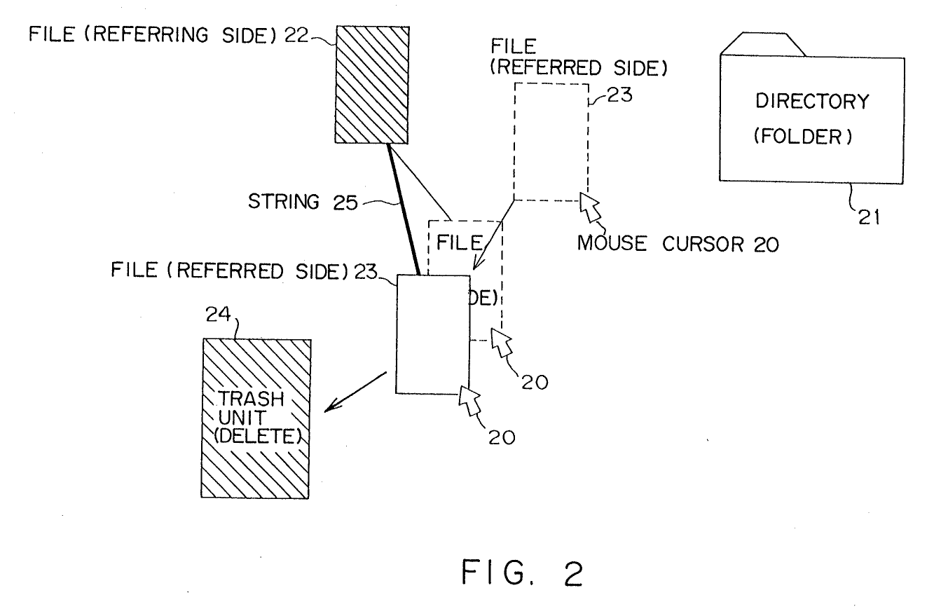

FIG. 2 is a schematic diagram showing an example of a display according to the present invention.

FIG. 2 shows an example of a display of a file management utility in a windows-type operating system. A directory (folder) 21 that stores a file 22 is displayed. In addition to the file 22, a file 23 stored in the folder 21 is displayed. An icon of a trash unit 24 as a utility for deleting a file is also displayed.

In FIG. 2, the files 22 and 23 are stored in the same folder 21 and displayed as files in the same level. It is assumed that when the file 22 is executed, the file 23 is used. In this case, if the file 23 is deleted, the file 22 cannot be normally executed.

In FIG. 2, a mouse cursor 20 is also displayed, and the user tries to drag the file 23 to the trash unit 24. At this point, according to the present invention, the system detects the relation by which the file 22 uses the file 23. The system displays a string 25 that connects an icon of the file 22 and an icon of the file 23. In addition to the string 25, an alarm sound may be generated.

With the string 25 displayed, since the user can know that the files 22 and 23 have the relation of dependency, he or she does not carelessly place a necessary file in the trash unit 24. At this point, when a file with the relation of dependency to another file is dragged, if an alarm sound is generated, a stronger effect can be obtained. However, whenever such a file is dragged, if an alarm sound is generated, it can be very disruptive. Thus, only when such a file is dragged to a predetermined region including the icon of the trash unit 24, is an alarm sound generated. At this point, whenever such a file is dragged, even if the string 25 is displayed, no problem occurs. Thus, whenever the file 23 is dragged, the string 25 is displayed.

In FIG. 2, the string 25 is displayed as a solid black line. However, according to the present invention, the string 25 is not limited to such a line. Instead, the string 25 may be a red line or a blue line. The string 25 may be a thin line. The string 25 may blink. Alternatively, the string 25 may be a dashed line or a double line, etc.

In the above description, the string 25 is connected between two files. Instead, the relation of dependency of two files may be displayed in different colors for the icons of these files. In this case, parameters representing the attributes of icons of files to be displayed are changed in a predetermined method provided by the windows-type operating system.

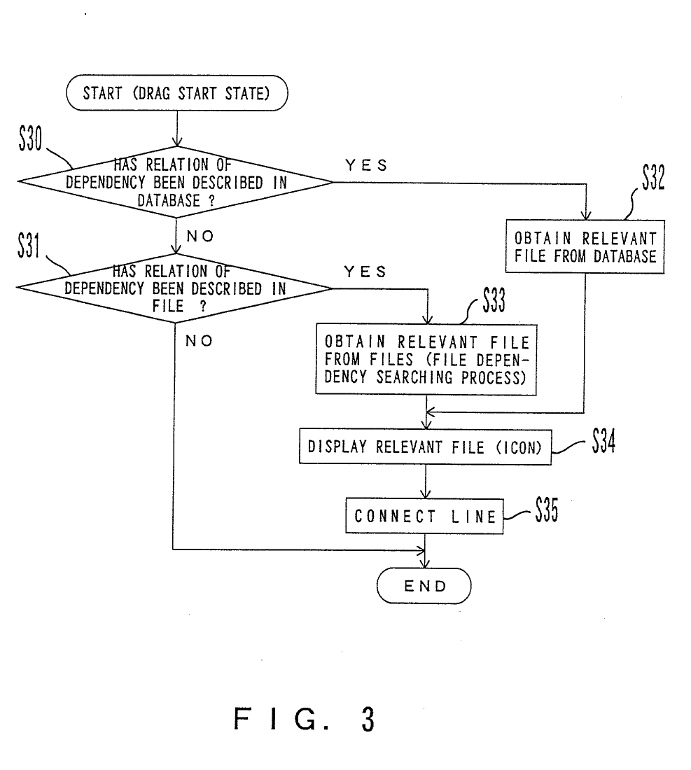

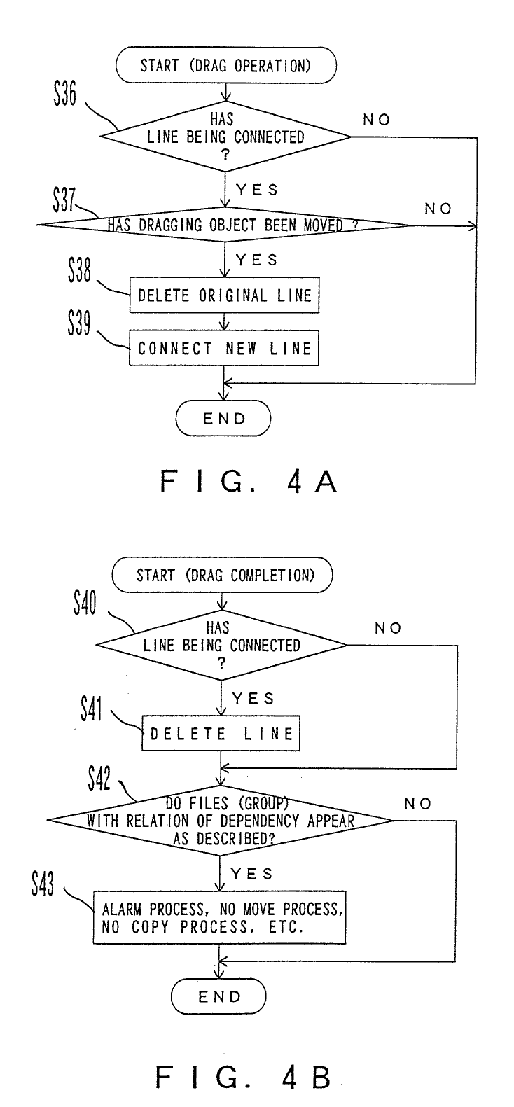

FIGS. 3, 4A, and 4B are flowcharts showing the overall process of the system according to the embodiment of the present invention.

The system according to the present invention is started when the file management utility of the windows-type operating system is started. When the file management utility is terminated, the system is also terminated. The system that has the process flow shown in FIGS. 3, 4A, and 4B is executed under the control of the windows-type operating system. In other words, the program that performs the process shown in FIGS. 3, 4A, and 4B is structured in an event-driven format. Whenever the system completes one process, it returns the process to the windows-type operating system. When an event (such as a drag operation of the mouse cursor) takes place, the system is started and performs the relevant process.

When the file management utility is started, the system waits until an event of a file operation takes place in the window of the file management utility. A real example of an event of a file operation is a drag operation of the mouse cursor for moving an icon of a file. When the icon of the file is dragged, the process shown in FIG. 3 is started.

At step S30 shown in FIG. 3, a database that records the relation of dependency of files is searched. It is determined that the relation of dependency of the file that has been dragged has been described in the database. The database has previously stored file names (on the referring side) (including the locations of directories that store the files) and file names on the referred side that are used when the files on the referring side are executed.

When the database has not stored the relation of dependency of the files, it is determined whether or not the relation of dependency has been described in the file that is being dragged (at step S31). When the relation of dependency has been described in the file, it is determined that the relation of dependency is known. Examples of files in which the relation of dependency have been described are executable files of the windows-type operating system and source files of the C language. The searching method of the relation of dependency for these files will be described later.

When the relation of dependency has not registered in the database as the determined result at step S30, and when the relation of dependency has not been described in the file as the determined result at step S31, it is determined that the file can be deleted. In this case, the process is completed without displaying the relation of dependency of files.

When the relation of dependency of the files has been described in the database as the determined result at step S30, the flow advances to step S32. At step S32, the relation of dependency of the files is searched in the database. A file with the relation of dependency to the file that is being dragged is obtained. Thereafter, the flow advances to step S34. When the relation of dependency has not been described in the database as the determined result at step S30, and when the relation of dependency has been described in the file as the determined result at step S31 (namely, the relation of dependency can be searched from the content of a file such as a system file of the windows-type operating system or a source file of the C language), the flow advances to step S33. The determination of whether the relation of dependency has been described in a file is performed by checking the extension of the file name. A system file of the windows-type operating system has been stored in a predetermined directory (for example, in the directory “¥windows”). Thus, in this case, the relation of dependency is determined by the stored location. In the case of a file that has described the relation of dependency, a file dependency searching process for analyzing the content of the file and extracting the relation of dependency should be performed. The details of the file dependency searching process will be described later.

After the relation of dependency of the files is obtained, an icon of a file with the relation of dependency to the file being dragged is displayed (at step S34). The icon of the file being dragged and the icon of the file with the relation of dependency thereto are connected with a line (at step S35). With Microsoft Visual C++ 4.0 (a product sold by the Microsoft Corporation), the program that connects a line is described as follows.

MoveTo (location of icon being dragged);

LineTo (location of icon with relation of dependency);

When these icons are connected with a line at step S35, the process is returned to the windows-type operating system. Thus, the system waits for an event of a file operation. Since the process shown in FIG. 3 connects a line between files with the relation of dependency, this process is started only when an event of a file drag operation takes place.

FIGS. 4A and 4B are flowcharts showing a process for an event of a file drag operation and a process for an event of a drag completion.

After a line is drawn between icons of files with the relation of dependency by the drag start event shown in FIG. 3, the event of the file drag operation causes the process shown in FIG. 4A to start. At step S36, it is determined whether or not a line has been connected between the icons of the files. When a line has not been drawn, the process is completed. When a line has been drawn, the flow advances to step S37. At step S37, it is determined whether or not an object (icon of a file) that is being dragged has been moved.

When the object being dragged has not been moved as the determined result at step S37, since the line drawn in the process shown in FIG. 3 is not changed, the process is completed. When the object being dragged has been moved as the determined result at step S37, the flow advances to step S38. At step S38, the original line is deleted. Thereafter, the flow advances to step S39. At step S39, the object (icon of the file) that has been moved and the icon of the file with the relation of the dependency thereto are connected with a new line. Thus, the process is completed.

The process shown in FIG. 4A is repeatedly started whenever the event of the file drag operation takes place in the windows-type operating system. Whenever this process is started, it is determined whether or not the object being dragged has been moved. When the object has been moved, a new line is drawn.

FIG. 4B shows a flowchart of a process that is started when an event of a drag completion takes place.

When the event of the drag completion in which the dragging of the object (icon of file) is completed is received from the windows-type operating system, the flow advances to step S40. At step S40, it is determined whether or not a line has been drawn between icons of files with the relation of dependency. When a line has been drawn between the icons, the flow advances to step S41. At step S41, the line is deleted. Thereafter, the flow advances to step S42. When a line has not been drawn as the determined result at step S40, the flow advances to step S42 skipping step S41.

At step S42, it is determined whether or not a file or a file group with the relation of dependency appears at the location of the relation of dependency obtained by the process shown in FIG. 3. When icons of files appear at the locations of the relation of dependency, since the relation of the locations of the files with the relation of dependency do not change, the files can be normally executed. Thus, the process is completed. When a file or a file group do not appear at the locations of the relation of dependency as the determined result at step S42, the flow advances to step S43. At step S43, an alarm is generated. Alternatively, a file is neither moved, nor copied. Thus, the process is completed.

The determining method of the process at step S42 has, for example, the following steps. At the first step, the user describes the relation of the location of a new file. At the second step, the description of the relation of the location and the relation of the location obtained from the database are compared. At the third step, when they match, it is determined that the icon of the file with the relation of dependency appears at the location as described. When they do not match, the icon of the file does not appear at the location as described as the determined result at step S42. In the method of which the relation of the location of the file is described at the first step, when the file is actually moved, by tracing the location of the file from the root directory, the absolute location can be obtained. The absolute location of the file on the referring side and the absolute location of the file on the referred side are removed from the absolute location of the common directory. The removed portion is substituted with, for example, “. . . └”. Thus, the relative location of the file on the referred side is obtained. Thus, it is determined whether or not the user's file operation maintains the relation of which a file appears at the location as described. Real examples of cases of whether or not an alarm is generated will be described later.

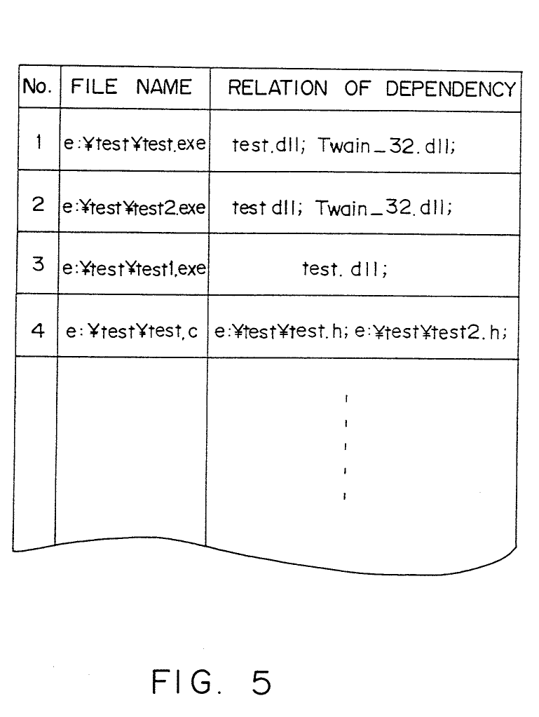

FIG. 5 shows an example of the database used in the process shown in FIG. 3.

Numbers in the first field on the left of the table are used to arrange the contents of the database. In the record 1, the full file name is “e:¥test¥test.exe”. In other words, the file name includes a drive name “e:” and a directory location “¥test” as well as a normal file name. Thus, the full file name represents the location. The extension of the normal file name is “exe” as in “test.exe” that represents that the file is an executable file.

A field “relation of dependency” includes files with the relation of dependency. In the record 1, when the file “test.exe” is executed, two files “test.dll” and “Twain_32.dll” are used.

In the record 2, when the file “e:¥test¥test2.exe” is executed, two files “test.dll” and “Twain_32.dll” are used at the same time. In the record 3, when a file “e:¥test¥test1.exe” is executed, a file “test.dll” is used. In the record 4, a source file “test.c” written in the C language is stored in a directory “¥test” of a drive “e:”. When the file “test.c” is used, two files “test.h” and “test2.h” that are header files of the C language files are used. These header files are stored in a directory “¥test” of a drive “e:”.

With such a database, files on the referring side and files on the referred side can be obtained. When the user tries to delete a file that affects the execution of another file, the system generates an alarm corresponding to the database contents.

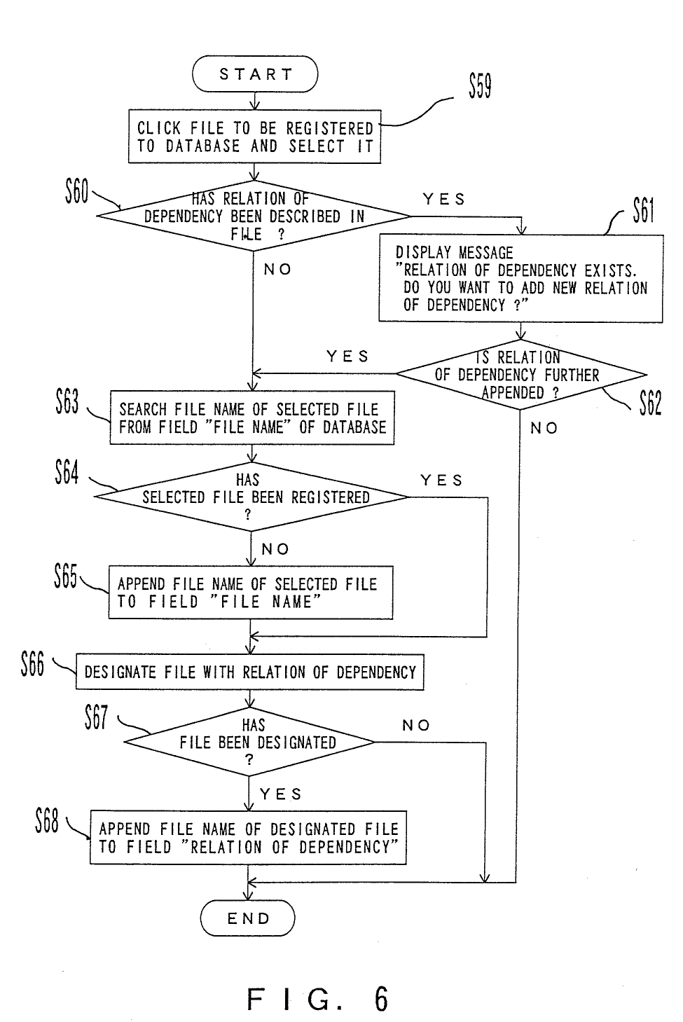

FIG. 6 is a flowchart showing a database creating process.

When the database creating process is started, the flow advances to step S59. At step S59, the user clicks an icon of a file to be registered to the database with the mouse. The extension of the file being selected and the directory thereof are checked so as to determine whether or not the relation of dependency has been described in the file as in a system file of the windows-type operating system or a source file of the C language (at step S60). When the relation of dependency has not been described in the file as the determined result at step S60, the flow advances to step S63. When the relation of dependency has been described in the file as the determined result at step S60, the flow advances to step S61. At step S61, for example, a message “RELATION OF DEPENDENCY EXISTS. DO YOU WANT TO ADD NEW RELATION OF DEPENDENCY?”. is displayed. Next, the flow advances to step S62. At step S62, it is determined whether or not the relation of dependency is registered to the database corresponding to the user input data. When the user has input “No”, the process is completed. When the user has input “Yes”, the flow advances to step S63.

At step S63, the file name of the selected file is searched from the field “file name” of the database. At step S64, it is determined whether or not the file name of the selected file has been registered in the database. When the file has been registered in the database, the flow advances to step S66. When the file has not been registered in the database as the determined result at step S64, the flow advances to step S65. At step S65, since the file name of the selected file has not been registered, the file name is newly appended to the file “file name” of the database. Thereafter, the flow advances to step S66.

At step S66, the user designates a file with the relation of dependency to the selected file. In other words, the user clicks an icon of a file with the relation of the dependency to the selected file or inputs a file name with the relation of the dependency to the window. At step S67, it is determined whether or not the user has designated a file with the relation of dependency to the selected file. When the user has not designated a file, the process is completed. When the user has designated a file, the file name thereof is newly appended to the field “relation of dependency” corresponding to the field “file name” at step S68. Thus, the process is completed.

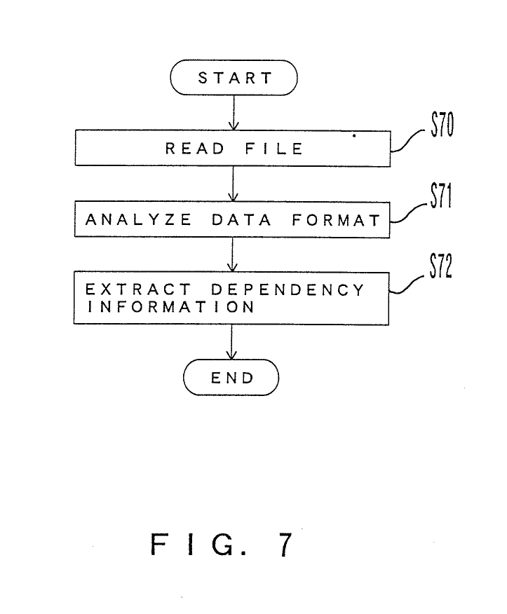

FIG. 7 is a flowchart of a file dependency searching process.

When a file being dragged has not been registered to the data base, if the relation of dependency of the file can be searched in a predetermined method (for example, the file is a system file of the windows-type operating system or a source file of the C language), the file dependency searching process is performed.

When an icon of a file is dragged, the file is read (at step S70) and the data format thereof is analyzed (at step S71). The data format is analyzed with the extension of the file name. When the extension of the file name of the file is “.exe”, the file is an executable file of the operating system. When the extension of the file name is “.c”, the file is a source file of the C language. When the data format is obtained, the file name of the file with the relation of dependency is extracted in a predetermined method (at step S72). After the file name is extracted, the flow advances to steps S34 and S35 shown in FIG. 3. At steps S34 and S35, the file with the relation of dependency and the file being dragged are connected with a line.

Next, with reference to the following drawings, a file name extracting method will be described.

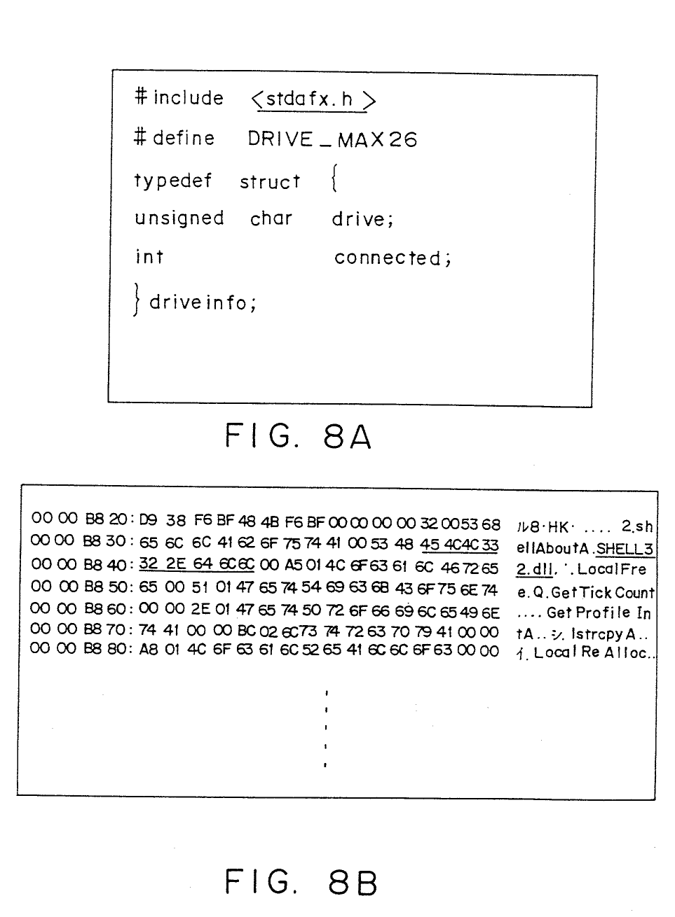

FIGS. 8A and 8B are schematic diagrams showing a source file in the C language and a system file of the windows-type operating system. In these drawings, only parts of the files are shown.

FIG. 8A shows a portion describing a file with the relation of dependency to another file. In the case of a source file of the C language, a file with the relation of dependency is described in brackets after “#include”, and to extract the file name of a file with the relation of dependency, the file name of this portion is extracted. In FIG. 8A, the source file describes that it uses a file “stdafx.h” (underlined). Thus, a program that automatically extracts the file name in the brackets after “#include” is created as a subroutine.

FIG. 8B shows a part of a system file of the windows-type operating system. In this case, the file management utility of the operating system has a program that extracts a file name with the relation of dependency. With this program, the file name can be automatically extracted. In FIG. 8B, the underlined portion is a file with the relation of dependency. The source file describes that it uses a file “SHELL32.DLL” when the source file is executed.

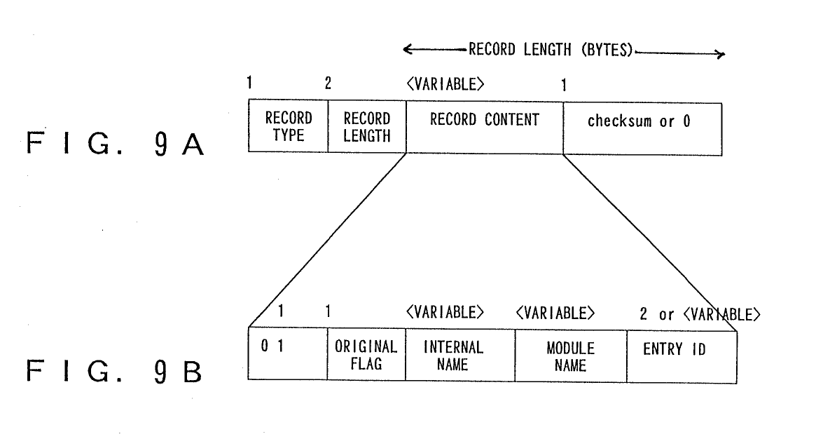

FIGS. 9A and 9B are schematic diagrams showing a record format of a system file of the windows-type operating system.

The record format shown in FIGS. 9A and 9B is based on an OMF (Relocatable Object Module Format). For details on OMF, see the Tool Interface Standard Portable Formats Specification Version 1.1, from the Intel Corporation, Order Number 241597. As shown in FIG. 9A, an OMF record is composed of “record type”, “record length”, “record content”, and “checksum or 0” as record items. The record length of the “record content” is variable. The content of the “record content” is shown in FIG. 9B.

The “record type” shown in FIG. 9A is “88H”. The “record content” has a record item “module name”. The “module name” describes the name of a file that is required when the executable file is executed. Thus, the file name described in the record item “module name” is extracted.

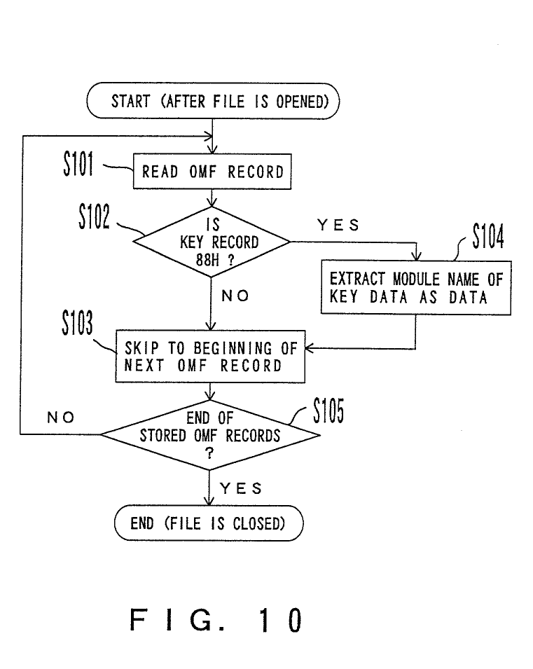

FIG. 10 is a flowchart showing a file name extracting process that extracts a file name with the relation of dependency from an executable file of the windows-type operating system.

First of all, the file is opened. Thereafter, an OMF record shown in FIGS. 9A and 9B is read from the file (at step S101). At step S101, a key record is obtained. At step S102, it is determined whether or not the key record (a record described in the “record type”) of the OMF record is “88H”. When the key record of the OMF record is “88H” as the determined result at step S102, the flow advances to step S104. At step S104, data described in the “module name” of the OMF record is extracted. The extracted data is the file name with the relation of dependency. The flow then advances to step S103. When the key record is not “88H” as the determined result at step S102, since the OMF record has not described a file name with the relation of dependency, the flow advances to step S103. At step S103, the beginning of the next OMF record is read. At step S105, it is determined whether or not the end of the OMF records has been read. When the end of the OMF records has not been read as the determined result at step S105, the flow returns to step S101. At step S101, a new OMF file is read. When the end of the OMF records has been read as the determined result at step S105, the file is closed. Thus, the process is completed.

A record having “88H” as a key record is treated as a record of a file with the relation of dependency. When the data is extracted, the file name with the relation of dependency is extracted from the executable file.

When all the OMF records has been searched as the determined result at step S105, and when data of module names have been extracted from all the OMF records having “88H” as the determined result at step S102, the file is closed. Thus, the process is completed.

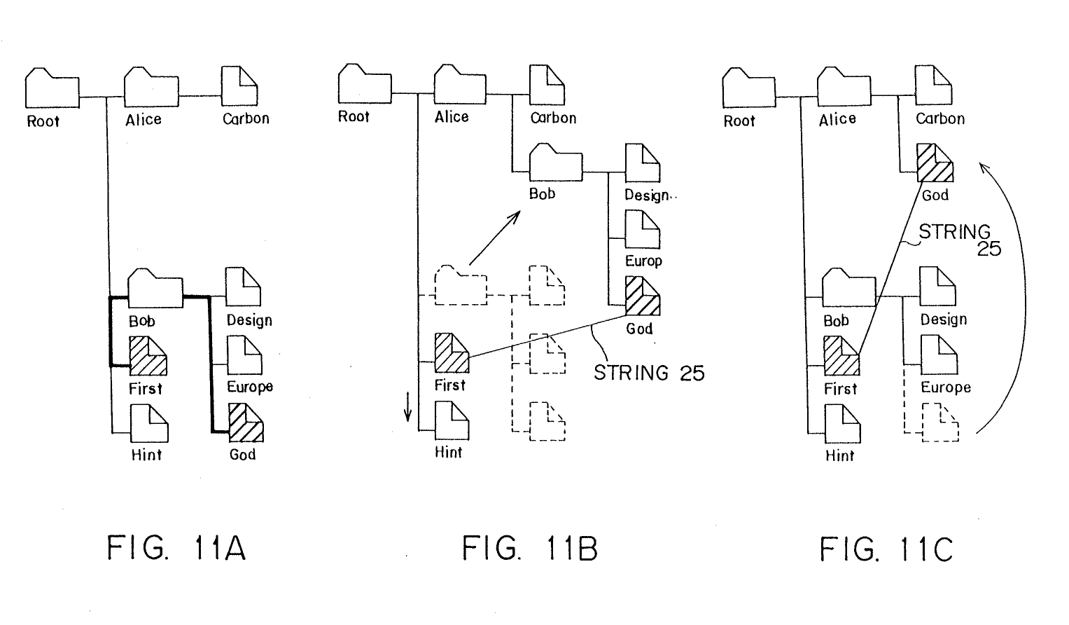

FIGS. 11A to 15B show a process that generates an alarm to the user and a process that does not generate an alarm to the user.

FIGS. 11A to 11C show a first example of a process that generates an alarm to the user, in the case that the relation of dependency of files is described as relative locations.

FIG. 11A shows the relation between files and a directory that have not been moved. Files that are hatched and connected with a solid line have the relation of dependency. However, the solid line is not actually displayed. In FIG. 11A, the solid line is drawn only for reference.

Now, it is assumed that a file “First” in a directory “Root” uses a file “God” in a directory “Bob”. In this case, the locations of the files are described as relative locations.

When the relation of dependency of the files is described as a relative relation, if the relative relation between the files “First” and “God” is changed, an alarm is generated.

In FIG. 11B, all files in the directory “Bob” are moved to a directory “Alice”. When the directory “Bob” is moved to the directory “Alice”, the relative locations of the files “First” and “God” are changed. At this point, the system displays a string 25. In addition, when the directory “Bob” is tried to be moved to the directory “Alice”, the system generates an alarm to the user.

In this display, the user can know that the files “First” and “God” have the relation of dependency. In addition, with the alarm, the user can be prevented from changing the relative positions of these files.

FIG. 11C shows another example of the process that generates the alarm to the user.

In FIG. 11C, only the file “God” with the relation of dependency to the file “First” is tried to be moved to the directory “Alice”. In this case, after the system recognizes that the files “First” and “God” have the relation of dependency, it displays a string 25 that connects these files. When the file “God” is tried to be moved to the directory “Alice”, the system generates the alarm sound to the user so that the user can know that the relation of dependency of the files “First” and “God” may be lost. Thus, the user can be prevented from moving the file “God”. Consequently, the relative positions between the files “First” and “God” are kept and thereby the file “First” can be normally executed.

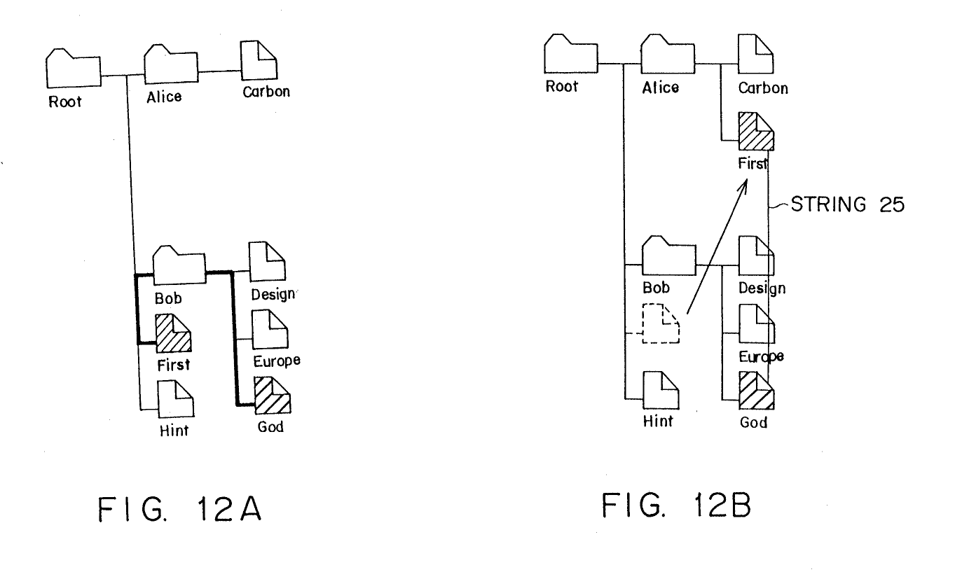

FIGS. 12A and 12B show a second example of the process that generates the alarm to the user, in the case that the relation of dependency of files is described as relative locations.

In FIG. 12A, files “First” and “God” have the relation of dependency. In FIG. 12A, the relation of dependency of these files is represented by a solid line. The solid line is drawn only for reference.

In other words, a file “First” in a directory “Root” uses a file “God” in a directory “Bob”.

In FIG. 12B, the user tries to move the file “First” that uses the file “God” to a directory “Alice”. In this case, since the files “First” and “God” have the relation of dependency, the system displays a string 25. When the user tries to move the file “First” to the directory “Alice”, the system generates the alarm to the user so as to inform him or her that since the relation of dependency of the files “First” and “God” is going to be changed, the file “First” will not be able to be normally executed.

The system knows that the file “First” uses the file “God” corresponding to the description of the file “First” in the database. When the user tries to perform an operation that destroys the relation of dependency, the system generates the alarm sound to him or her so that he or she can be prevented from making such an operation.

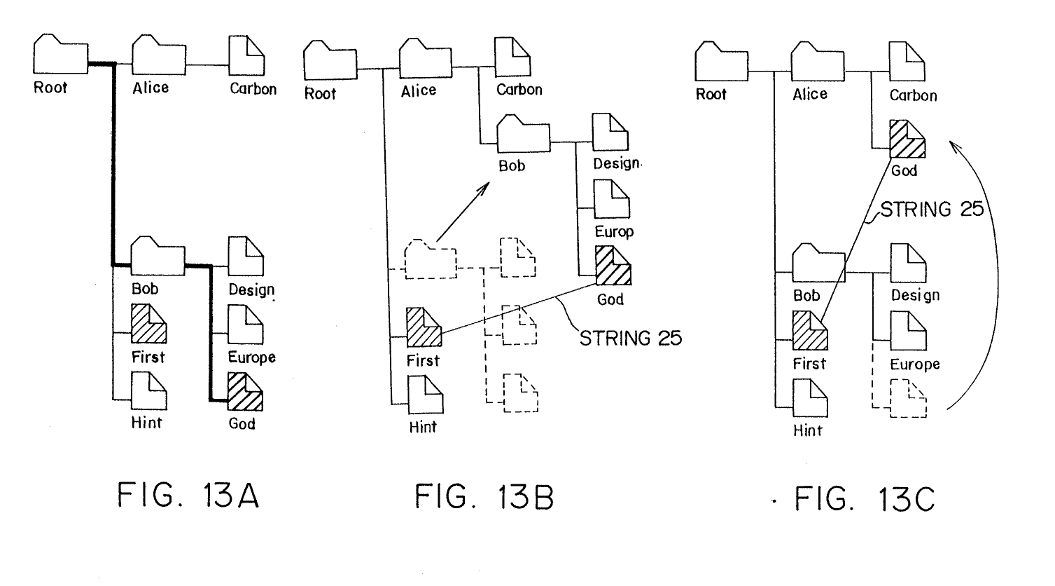

FIGS. 13A to 13C show an example of a process that generates an alarm, in the case that the relation of dependency of files is described as absolute locations.

In FIG. 13A, the location of a file “God” with the relation of dependency to a file “First” is described as an absolute location from a directory “Root”. In other words, the file “First” uses the file “God” in the directory “Bob” in the directory “Root”. A solid line represents the absolute location of the file “God” that is used by the file “First”. The files “First” and “God” with the relation of dependency are hatched.

FIG. 13B shows an example of which a directory “Bob” of the file “God” that the file “First” uses is moved to a directory “Alice”. In this case, since the files “First” and “God” have the relation of dependency, the system connects the two icons of these files with a string 25. When the user tries to move the directory “Bob” to the directory “Alice”, the system generates an alarm sound to the user so that he or she can be prevented from moving the directory “Bob”.

FIG. 13C shows an example of which the file “God” with the relation of dependency to the file “First” is moved from the directory “Bob” to the directory “Alice”. When the user tries to move the file “God” in the directory “Bob” to the directory “Alice”, since the files “First” and “God” have the relation of dependency, the system displays a string 25. When the user tries to move the file “God” to the directory “Alice”, the system generates an alarm sound so that he or she can be prevented from moving the file “God”.

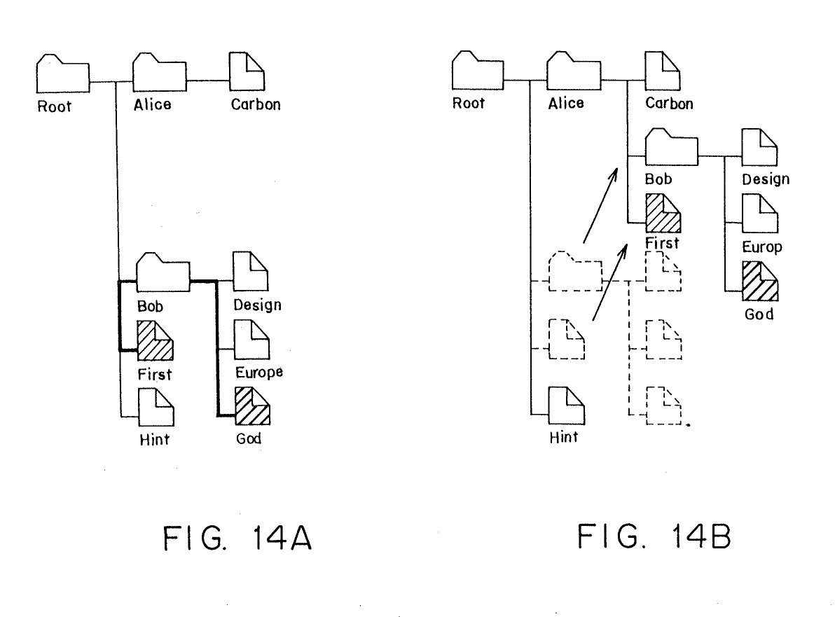

FIGS. 14A and 14B show an example of a process that does not generate an alarm to the user, in the case that the relation of dependency of files is described as relative locations.

FIG. 14A shows the relation between files “First” and “God”. In FIG. 14A, a file “First” in a directory “Root” uses a file “God” in a directory “Bob”. The relation of dependency of these files is designated as relative locations.

FIG. 14B shows an example in which the user tries to move the directory “Bob” and the file “First” to the directory “Alice”. In this case, the relation locations of the files “First” and “God” are not changed. In other words, since the relation in which the file “First” uses the file “God” in the directory “Bob” is not changed, the system does not generate an alarm to the user. In addition, the system does not display a string. Thus, when the file with the relation of dependency to the file “First” is described as a relative location, unless the relation of the relative locations might be destroyed, the file “First” can be normally executed. Thus, the files and the directory can be moved as shown in FIG. 14B.

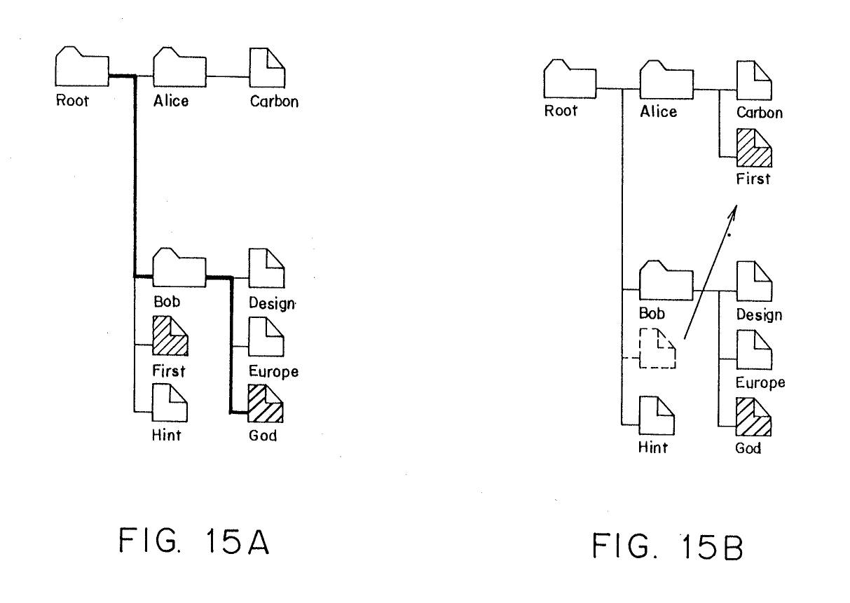

FIGS. 15A and 15B show an example of a process that does not generate an alarm to the user, in the case that the relation of dependency of files is described as absolute locations.

FIG. 15A shows the case that the location of a file “God” that a file “First” uses is described as an absolute location from a directory “Root”. In other words, the database or the file “First” describes the file “God” in the directory “Bob” in the directory “Root” as a file with the relation of dependency. In FIG. 15A, a solid line represents that the location of the file “God” is designated as an absolute location.

FIG. 15B shows the case that the user moves the file “First” that uses the file “God” to the directory “Alice”. The user drags the icon of the file “First” to the directory “Alice” with the mouse cursor.

In this case, although the location of the file “First” is changed, when the file “First” is executed, the file “God” is searched for with the absolute location from the directory “Root”. Thus, the absolute location of the file “God” is not changed, even if the file “First” is moved. Consequently, since the file “First” can search for the file “God”, the file “First” can be normally executed. In this case, the system does not generate an alarm to the user. In other words, the system permits this operation.

The system determines whether the relation of dependency of files is described as relative locations or absolute location with the description of the file name with the relation of dependency. For example, when a file is designated as an absolute location, a drive name, a directory name, and a file name are described as follows.

“e:¥test¥test1.h”

On the other hand, when a file is designated as a relative location, a symbol that represents a directory of one level higher, a directory of the next level, and a file name are described as follows.

“. . .¥test¥test1.h”

where “. . .¥” represents the directory one level higher viewed from the file on the referring side.

Thus, depending on whether or not “. . .¥” is followed by the file name on the referred side, it is determined whether the location of the file on the referred side is designated as an absolute location or a relative location.

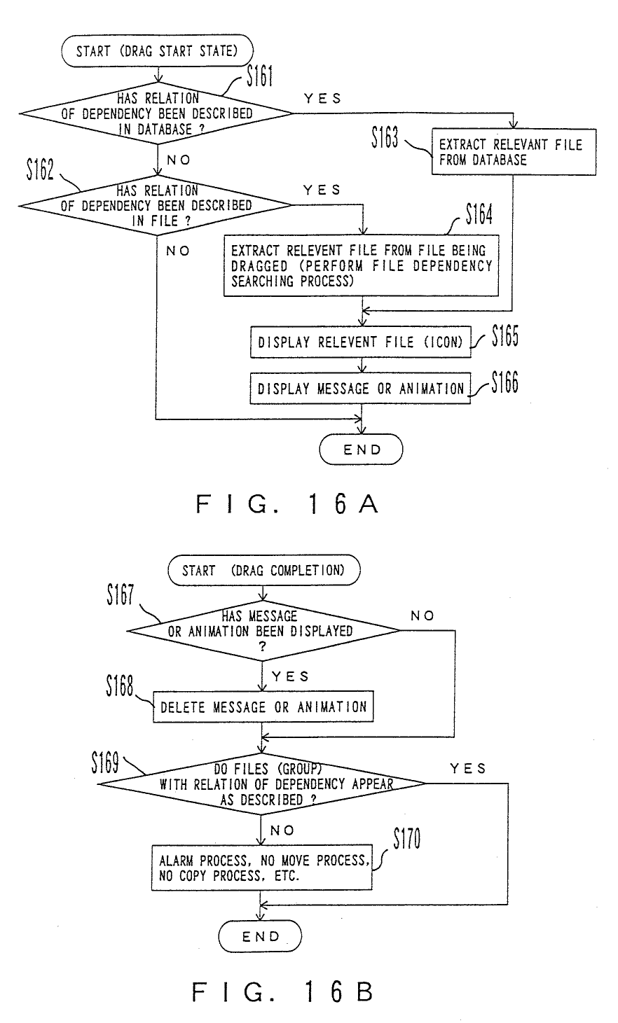

FIGS. 16A and 16B are flowcharts for explaining a process according to another embodiment of the present invention.

The flowcharts shown in FIGS. 16A and 16B are basically the same as the flowcharts shown in FIGS. 3, 4A, and 4B. However, the flowcharts shown in FIGS. 16A and 16B do not have processes in the dragging state. In addition, in the processes shown in FIGS. 16A and 16B, the icons of two files are not connected with a line. In these processes, a message or an animation that represents that two files have the relation of dependency is output.

Steps S161 to S165 shown in FIG. 16A are equivalent to Steps S30 to S34 shown in FIG. 3. When a drag start event takes place in the windows-type operating system, the process is started.

When the process is started, it is determined whether or not the relation of dependency has been described in the database (at step S161). This determination is performed depending on whether or not the file name being dragged has been described in the database. When the relation of dependency has been described in the database as the determined result at step S161, the flow advances to step S163. At step S163, a relevant file is extracted from the database. Then, the flow advances to step S165. When the relation of dependency has not been described in the database as the determined result at step S161, the flow advances to step S162. At step S162, it is determined whether or not the relation of dependency has been described in the file. This is because when a system file of the windows-type operating system or a source file of the C language is dragged, the relation of dependency can be extracted.

When the dragged file has not been registered in the database as the determined result at step S161 and when the relation of dependency has not been described in the file as the determined result at step S162, the file can be deleted. At this point, the system does not display the relation of dependency. Thus, the process is completed.

When the relation of dependency has been described in the file, the flow advances to step S164. At step S164, a relevant file is extracted from the file being dragged (the file dependency searching process is performed). The file dependency searching process is performed corresponding to the flowchart shown in FIG. 7.

When the relation of dependency of the files has been extracted at step S164 or the relation of dependency has been extracted from the database at step S163, an icon of a relevant file is displayed (at step S165). A message or an animation is displayed corresponding to the relation of dependency being extracted (at step S166). Then, the process is completed.

A message or an animation has been prepared as an object. At step S166, the message or animation is displayed at a proper location. An object of a message is composed of a definition of a window and a message. An object of an animation is composed of a definition of a pattern and a method for displaying the definition.

When a message is displayed on Microsoft Windows 95, a source code for displaying a message is, for example, as follows.

MessageBox (GetDesktopWindow( ), “File b is used by file a.” MB_ICONINFORMATION| MB_OK);

A source code for displaying an animation is, for example, as follows.

Init CommonControls( ); //Activates the function Animate_xxxx.

HWND hAnimate=Animate_Create (GetDesktopWindow ( ), 1, WS_CHILD| WS_BORDER| WS_VISIBLE hlnst); //Creates a window for an animation.

Animate_Open(hAnimate“TEST.AVI”);//Reproduces TEST.AVI file.

Animate_Play(hAnimate,0, (WORD),1,1); //Reproduces data from top frame (0) to last frame (I) one time.

The source codes above are only display portions. In reality, functions for calling these source codes are required.

FIG. 16B is a flowchart showing a process that is performed in the case that a drag completion event takes place.

In FIG. 16B, the same process is performed as the process shown in FIG. 4B except that a message or an animation is processed instead of a process for connecting the icons of files with the relation of dependency using a line. In the process shown in FIG. 16B, the process corresponding to FIG. 4A is omitted. This is because when a line is drawn, it should be moved corresponding to the movement of an icon of a file.

When the drag completion event takes place, the process shown in FIG. 16B is performed. At step S167, it is determined whether or not a message or an animation has been displayed. When a message or an animation has not been displayed as the determined result at step S167, the flow advances to step S169. When a message or an animation has been displayed as the determined result at step S167, it is deleted (at step S168). Next, the flow advances to step S169.

At step S169, it is determined whether or not a file or a file group with the relation of dependency appears at the described location in the above-described method. When a file (group) with the relation of dependency appears at the described location as the determined result at step S169, the process is completed. When a file (group) with the relation of dependency does not appear at the described location as the determined result at step S169, the flow advances to step S170. At step S170, the system generates an alarm to the user. At this point, a moving process or a copy process is prevented from being performed. Thus, the process shown in FIG. 16B is completed.

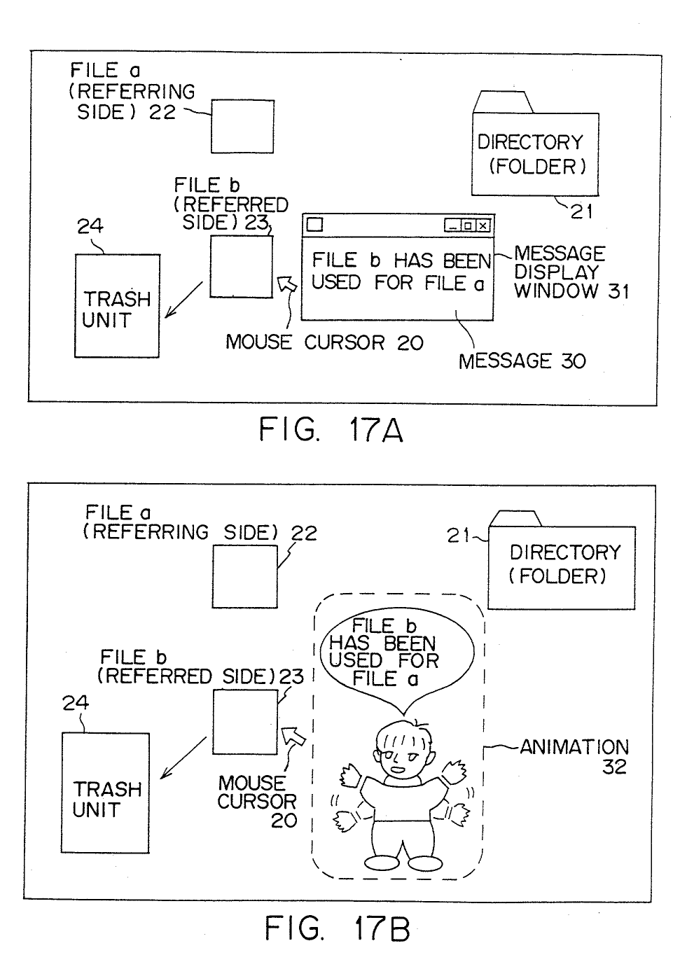

FIGS. 17A and 17B are schematic diagrams showing examples of a message and an animation displayed on a screen.

FIG. 17A shows an example of a message displayed on a screen.

In FIG. 17A, a file management utility of the windows-type operating system is started. A directory (folder) 21, files 22 and 23, a trash unit 24, and a mouse cursor 20 are displayed. In FIG. 17A, the user is dragging the file b 23 to the trash unit 24 with the mouse cursor 20. When the file b 23 is dragged, the relation of dependency of the file b is extracted from the database or the content of the file b. Thus, the relation of which the file b is used by the file a is extracted.

Thus, when the file b 23 is dragged, the message 30 is displayed. In this case, the content of the message is not limited, as long as the message represents that the file b is used by the file a. In FIG. 17A, a message display window 31 is displayed. In the message display window 31, a message is displayed. The display location of the message is not limited. However, the location of the message is preferably close to the file b 23 that is used by the file a 22.

FIG. 17B shows an example of an animation being displayed.

In FIG. 17B, the file management utility is started. A directory (folder) 21, files 22 and 23, a trash unit 24, and a mouse cursor 20 are displayed. The user is dragging the file b 23 to the trash unit 24 with the mouse cursor 20. At this point, the relation of dependency of the file b 23 is checked and thereby the relation of which the file b 23 is used by the file a 23 is extracted.

Thus, an animation representing that the file b 23 is used by the file a 22 is displayed. The animation is not limited as long as it represents the relation of files. In FIG. 17B, a boy waves his hands so as to give a warning to the user. In addition, a message “FILE B IS USED BY FILE A.” is displayed. Thus, the animation and message cause the user to understand the relation of the files. The waving operation of the animation can be easily accomplished by a method for varying the definition of a picture by a predetermined method, when the animation is defined as an object.

According to the present invention, the user does not need to determine whether a file he or she tries to operate has the relation of dependency of another file. In addition, with visual information that represents that a file being operated has the relation of dependency to another file, a more user-friendly interface can be provided.

Although the present invention has been shown and described with respect to best mode embodiments thereof, it should be understood by those skilled in the art that the foregoing and various other changes, omissions, and additions in the form and detail thereof may be made therein without departing from the spirit and scope of the present invention.

What is claimed is:

1. An apparatus for graphically displaying a file and operating the file, and outputting the relation between a first file and a second file when the first file is operated, the first file using the second file when the first file is executed.

2. An apparatus for graphically displaying a file and operating the file, and outputting the relation between a first file and a second file when the second file is operated, the first file using the second file when the first file is executed.

3. The apparatus as set forth in claim 1 or 2,
wherein the relation between the first file and the second file is displayed with a line connecting an image of the first file and an image of the second file.

4. The apparatus as set forth in claim 1 or 2,
wherein the operation of the first file or the second file is the deletion of the second file.

5. The apparatus as set forth in claim 4,
wherein when the second file is tried to be deleted, an alarm sound is generated.

6. The apparatus as set forth in claim 1 or 2,
wherein the apparatus stores files in directories, and
wherein the operation of the first file or the second file is the moving of a directory containing some files.

7. The apparatus as set forth in claim 1 or 2,
wherein the apparatus stores files in directories, and
wherein the operation of the first file or the second file is the deletion of a directory containing some files.

8. The apparatus as set forth in claim 1 or 2,
wherein when the first file or the second file is tried to be moved to a location where the second file cannot be searched when the first file is executed, an alarm sound is generated.

9. The apparatus as set forth in claim 1 or 2,
wherein the relation between the first file and the second file is output as a message that represents that the first file and the second file have a relation.

10. The apparatus as set forth in claim 1 or 2,
wherein the relation between the first file and the second file is displayed as an animation that represents the relation between the first file and the second file.

11. The apparatus as set forth in claim 1 or 2,
wherein the relation between the first file and the second file is displayed in different colors.

12. A recording medium storing a program that causes a computer for graphically displaying files and performing a file operation to perform the function of:
outputting the relation between a first file and a second file when the first file is operated, the first file using the second file when the first file is executed.

13. A recording medium storing a program that causes a computer for graphically displaying files and performing a file operation to perform the function of:
outputting the relation between a first file and a second file when the second file is operated, the first file using the second file when the first file is executed.

14. An apparatus for graphically displaying a file and operating the file, comprising:
detecting means for detecting whether or not a file is being operated;
searching means for searching for a file with the relation of dependency to the file detected by said detecting means; and
alarming means for generating an alarm when said searching means has obtained a file with the relation of dependency to the file detected by said detecting means.

15. An apparatus for graphically displaying a file and operating the file, comprising:
detecting means for detecting whether or not a file is being operated;
searching means for searching for a file with the relation of dependency to the file detected by said detecting means;
determining means for determining whether or not the relation of dependency between the file obtained by said searching means and the file detected by said detecting means will be destroyed by the file operation; and
alarming means for generating an alarm only when said determining means has determined that the relation of dependency will be destroyed.

16. The apparatus as set forth in claim 14 or 15,
wherein the alarm generated by said alarming means is a visible alarm.

17. The apparatus as set forth in claim 14 or 15,
wherein the alarm generated by said alarming means is an audible alarm.

18. The apparatus as set forth in claim 14 or 15,
wherein the alarm generated by said alarming means is a combination of a visible alarm and an audible alarm.

19. The apparatus as set forth in claim 14 or 15,
wherein the alarm generated by said alarming means is a visible alarm in which an image of the file being operated and an image of the file that has the relation of dependency to the file being operated are connected with a line.

20. The apparatus as set forth in claim 14 or 15,
wherein the file operation is the deletion of the file.

21. The apparatus as set forth in claim 14 or 15,
wherein the apparatus stores the file in a directory, and
wherein the file operation is the moving of the directory containing the file.

22. The apparatus as set forth in claim 14 or 15,
wherein the apparatus stores the file in a directory, and
wherein the file operation is the deletion of the directory containing the file.

23. The apparatus as set forth in claim 14 or 15,
wherein the alarm is a message representing that the file detected by said detecting means and the file obtained by said searching means have a relation.

24. The apparatus as set forth in claim 14 or 15,
wherein the alarm is an animation representing that the file detected by said detecting means and the file obtained by said searching means have a relation.

25. The apparatus as set forth in claim 14 or 15,
wherein the alarm is displayed in different colors.

26. A recording medium storing a program that causes a computer for graphically displaying a file and operating the file to perform the functions of:
detecting whether or not a file is being operated;
searching for a file with the relation of dependency to the file detected by the detecting function; and
generating an alarm when the searching function has obtained a file with the relation of dependency to the file detected by the detecting function.

27. A recording medium storing a program that causes a computer for graphically displaying a file and operating the file to perform the functions of:
detecting whether or not a file is being operated;
searching for a file with the relation of dependency to the file detected by the detecting function;
determining whether or not the relation of dependency between the file obtained by the searching function and the file detected by the detecting function will be destroyed by the file operation; and
generating an alarm only when said determining function has determined that the relation of dependency will be destroyed.

28. A method for graphically displaying a file and operating the file, comprising the steps of:
outputting the relation between a first file and a second file when the first file is operated, the first file using the second file when the first file is executed.

29. A method for graphically displaying a file and operating the file, comprising the steps of:
outputting the relation between a first file and a second file when the second file is operated, the first file using the second file when the first file is executed.

30. A method for graphically displaying a file and operating the file, comprising the steps of:
detecting whether or not a file is being operated;
searching for a file with the relation of dependency to the file detected by said detecting step; and
generating an alarm when said searching step has obtained a file with the relation of dependency to the file detected by said detecting step.

31. A method for graphically displaying a file and operating the file, comprising the steps of:
detecting whether or not a file is being operated;
searching for a file with the relation of dependency to the file detected by said detecting step;
determining whether or not the relation of dependency between the file obtained by said searching step and the file detected by said detecting step will be destroyed by the file operation; and
generating an alarm only when said determining step has determined that the relation of dependency will be destroyed.

32. An apparatus for graphically displaying a name or icon of file and operating the file, and outputting the relation between a first file and a second file when the first file is operated, the first file using the second file when the first file is executed.

33. A recording medium storing a program that causes a computer for graphically displaying a name or icon of file and performing a file operation to perform the function of:
outputting the relation between a first file and a second file when the first file is operated, the first file using the second file when the first file is executed.

34. An apparatus for graphically displaying a name or icon of file and operating the file, comprising:
detecting means for detecting whether or not a file is being operated;
searching means for searching for a file with the relation of dependency to the file detected by said detecting means; and
alarming means for generating an alarm when said searching means has obtained a file with the relation of dependency to the file detected by said detecting means.

35. A recording medium storing a program that causes a computer for graphically displaying a name or icon of file and operating the file to perform the functions of:
detecting whether or not a file is being operated;
searching for a file with the relation of dependency to the file detected by the detecting function; and
generating an alarm when the searching function has obtained a file with the relation of dependency to the file detected by the detecting function.

36. A recording medium storing a program that causes a computer for graphically displaying a name or icon of file and operating the file to perform the functions of:
detecting whether or not a file is being operated;
searching for a file with the relation of dependency to the file detected by the detecting function;
determining whether or not the relation of dependency between the file obtained by the searching function and the file detected by the detecting function will be destroyed by the file operation; and
generating an alarm only when said determining function has determined that the relation of dependency will be destroyed.

37. A method for graphically displaying a name or icon of file and operating the file, comprising the steps of:
detecting whether or not a file is being operated;
searching for a file with the relation of dependency to the file detected by said detecting step; and
generating an alarm when said searching step has obtained a file with the relation of dependency to the file detected by said detecting step.
